(19) United States
(12) Patent Application Publication
(10) Pub. No.: US 2021/0264381 A1
(43) Pub. Date: Aug. 26, 2021

(54) SHIFT IDENTIFICATION

(71) Applicant: Steady Platform LLC, Atlanta, GA (US)

(72) Inventors: Marcel Crudele, Atlanta, GA (US); Amanda Miguel, Atlanta, GA (US); Heather Arentson, Atlanta, GA (US)

(21) Appl. No.: 17/177,276

(22) Filed: Feb. 17, 2021

Related U.S. Application Data
(60) Provisional application No. 62/980,529, filed on Feb. 24, 2020.

(51) Int. Cl. G06Q 10/10; G06N 20/00; G06N 5/04; G01S 19/51

(52) U.S. Cl. CPC G06Q 10/1097; G01S 19/51; G06N 5/04; G06N 20/00

(57) ABSTRACT

The example embodiments are directed to a method and system which can identify shifts within employment data and use the identified shifts to organize data and execute additional analytics on the data. In one example, the method may include receiving geopositional data and timing data from a computing device associated with a user, identifying a set of tasks that were performed based on changes in one or more of the geopositional data and the timing data, determining that a first subset of tasks from the set of tasks are included in a first shift and a second subset of tasks from the set of tasks are included in a second shift based on a gap in time between a last task of the first subset and a first task of the second subset, and storing timing values of the determined first and second shifts in a data store.

### CROSS-REFERENCE TO RELATED APPLICATIONS

This application claims the benefit under 35 USC § 119(e) of U.S. Provisional Application No. 62/980,529, filed on Feb. 24, 2020, in the United States Patent and Trademark Office, the entire disclosure of which is hereby incorporated by reference for all purposes.

### BACKGROUND

Users are more connected on the Internet than ever before. This hyper-connected society has opened up new opportunities and avenues for making money. For example, picking up a temporary work engagement (e.g., a gig) is easy and made possible through many forums, mobile apps, websites, and the like. As a result of the “gig economy,” people increasingly have multiple sources of income that blends together full-time, part-time, on-demand, one-off, and gig work. These individuals are faced with the challenge of generating the most income from the sources available to them by balancing a number of things such as limitations on the amount of work available, scheduling constraints, work-related expenses, variable compensation, alternative sources of income, and the like. What is needed is a way that can help a user visualize and optimize how they can best make money.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1A is a diagram illustrating an architecture of a host platform including an insight engine in accordance with an example embodiment.

FIG. 1B is a diagram illustrating an architecture of a shift identification and machine learning layers in accordance with an example embodiment.

FIGS. 2A and 2B are diagrams illustrating examples of a user interface for displaying insight and recommendations in accordance with example embodiments.

FIG. 3 is a diagram illustrating tasks performed by a user over a period of time in accordance with an example embodiment.

FIGS. 4A and 4B are diagrams illustrating a process of inferring start and stop times when the start and stop times are omitted (not present) in the user data in accordance with example embodiments.

FIGS. 5A and 5B are diagrams illustrating a process of identifying shifts from a group of tasks in accordance with an example embodiment.

FIG. 6A is a diagram illustrating a process of organizing data based on detected shifts in accordance with an example embodiment.

FIG. 6B is a diagram illustrating a process of querying data based on shift parameters in accordance with an example embodiment.

FIG. 7 is a diagram illustrating a method of detecting a shift within user data in accordance with an example embodiment.

FIG. 8 is a diagram illustrating a computing system for use in the example embodiments described herein.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, details are set forth to provide a thorough understanding of various example embodiments. It should be appreciated that modifications to the embodiments will be readily apparent to those skilled in the art, and generic principles defined herein may be applied to other embodiments and applications without departing from the spirit and scope of the disclosure. Moreover, in the following description, numerous details are set forth as an explanation. However, one of ordinary skill in the art should understand that embodiments may be practiced without the use of these specific details. In other instances, well-known structures and processes are not shown or described so as not to obscure the description with unnecessary detail. Thus, the present disclosure is not intended to be limited to the embodiments shown, but is to be accorded the widest scope consistent with the principles and features disclosed herein.

The example embodiments are directed to a platform that can recommend different employment opportunities to a user in order to improve how much income the user makes on a daily or hourly basis. In some embodiments, the platform may suggest a different work schedule, rather than a different job. As another example, the platform may suggest a training course or license to obtain in order to increase the income.

The example embodiments use machine learning models to collaboratively learn from a community of users and provide predictions to individuals based on data provided from a larger group. This enables sensitive information of the group of users to be used to provide predictions for another user, while at the same time keeping the sensitive information hidden. The platform can process the information via machine learning models to predict better opportunities for a user. The opportunities may be based on a particular job category, a particular geographical area, a particular time/day that the user desires to work, and the like.

With the advent of the “gig economy,” people increasingly have multiple sources of income, frequently blending full-time, part-time, on-demand, one-off, and gig work. These workers are faced with the challenge of generating the most income from the sources available to them by balancing a number of things.
Limitations on the amount of work available. One of the easiest ways to increase income can simply be working more hours, however not all work allows this. Some income sources limit the number of hours available to workers, require registration for “shifts” ahead of time, or simply don't have the demand to offer workers more time.
Scheduling constraints. Workers have constraints on both the amount of time they can work and when they can work. For the most part, if they are working for one income source, they can't simultaneously be working for a second source of income. Additionally, workers might have other periods of time they are unavailable for work, which might be limitations like the schedules of their spouse and children. Even if additional hours are available for work, these other limitations factor in to when workers can take advantage of those hours.
Work-associated expenses. Work has additional expenses associated with it that impacts Net Income. Work far from a worker's home has transportation costs, such as fuel and wear-and-tear on the worker's own vehicle or public transportation costs. The time spent in transit also represents an opportunity cost—traveling an hour for a job could be an hour spent working for other income sources. Non-transit expenses are also a factor, such as cost of uniforms and other equipment, child-care costs during work hours, etc. All of these should ideally be taken into account to make the best decision of what work is the most beneficial to the worker.
Variable compensation. For some sources of income, the compensation may not be consistent for all times worked. By way of example, some gigs allow you to work on-demand, but that is no guarantee that income per hour will be the same. Demand, tips, bonuses, and time to perform work may vary dramatically based on time, location, weather, local events, and other factors that can dramatically affect income. Other work may also have variable compensation—for instance, a night shift may pay more than a day shift or there might be additional compensation in the form of overtime pay.
Alternative sources of income. In addition to income sources already established by workers is the ongoing search for new income sources that could result in improved income levels based on all of the factors above. For example, a new income source that pays more per hour, with no associated expenses, close to the worker's home, with increased flexibility of scheduling, and an unlimited amount of available hours that the worker is qualified for would have significant appeal. However, any combination of those factors could also make sense for a worker's specific needs compared to or in conjunction with existing income sources. Finding and evaluating these new opportunities is part of the challenge of workers today.

These are all examples of the enormous number of factors that workers must consider. What is needed is a way to collect and evaluate information about workers as individuals as well as communities of workers in order to help make sense of all of the data. Presenting the underlying data in a way that helps workers make decisions and proactively offers insights and recommendations to workers is what is proposed.

Before the data can be presented in an understandable and insightful way, the data must be grouped together to enable insights and recommendations to be identified, for example, using machine learning and other analytical methods. Raw data can be entered from different sources, for example, spreadsheets, user interfaces, table data, and the like, and can include different types of data including geopositional data (GPS), timing data, financial data, etc. This data is often provided in different formats and can lack coherency. Before this data can be used, the system described herein can bin the data into smaller subsets based on shifts identified from the data. These “shifts” refer to a continuous period of time where a user was working a particular job or duty. An example of a shift is 6 hours spent delivering food as a delivery driver. Here, the single 6 hour shift may include a plurality of different tasks (e.g., deliveries, etc.).

To identify shifts performed by a person it may be necessary to first identify the tasks performed by the person, and then identify which tasks are part of a first shift and which tasks are part of a second shift, etc. By binning data into shifts, further insights and recommendations can be performed. For example, the shifts can be used to predict better income earning opportunities (per shift) for the user. As another example, the shifts can be used to predict a change in schedule for the user to help the user earn more income or adjust to other factors. Accordingly, the shift identification may be useful to perform analytics, provide metrics, compare income opportunities, and the like. Here, the shift identification may be performed by the income optimization platform, or a mutually exclusive system.

Gig workers may perform multiple tasks in sequence that they receive payment for. The tasks may be related to the same gig opportunity or different opportunities. For example, a user may perform a delivery task for a first company followed by a driving task for a second company. Then, the user may take a break for an hour or so and then perform more tasks. The platform may receive this information and distinguish one set of data from the other based on shift identification. In some embodiments, these tasks may be grouped into different shifts or they may be grouped into one larger shift.

In some embodiments, users may provide information indicating a start and an end of a group of tasks that are performed over a period of time. In this case, the system can simply identify shifts based on the information expressly provided by the user. However, there are often times when users do not provide start/stop shift information. Furthermore, identifying this information can be difficult for gig economy workers who may be waiting for a next task or driving/travelling to the next task which does not appear like they are earning income but should still be considered part of a single shift. This is time they are engaged in trying to work and may be taken into account to calculate an hourly rate.

To address this, the system described herein may identify “shifts” based on the timing information of the tasks performed by the user. The system may include logic (e.g., machine learning algorithms) that looks at the task information and clusters it to identify times people seem to be actively working or looking for work. The simple approach is, if the start time of a task is within a predetermined period of time (e.g., 60 minutes, 90 minutes, etc.) of the end of the previous task, the system may detect these tasks as being part of the same shift. What constitutes this predetermined period of time may be identified by the machine learning algorithm based on various factors such as geolocation of the shift information, a type of job being performed (e.g., ride share, home care, laborer, etc.), community information provided by other users, and the like. Once the shift is identified, the system may then perform additional analysis of the data to generate and provide insight and recommendations to the user.

An additional nuance is that in some cases the system may only have a start time of a task and not an end time. In this example, the system may implement logic that analyzes community task information and statistically determines an end time for the task based on other similar tasks. The initial implementation may be very basic. However, an advanced analysis can determine the end time estimate based on time of day, geography, time of task being performed, and the like. This latter implementation may be performed using collaborative learning (e.g., collaborative filtering, etc.)

For example, a user may perform a group of tasks over the course of a predetermined period of time (e.g., 12 hours, 18 hours, 24 hours, etc.). Within that predetermined period of time may be multiple “shifts” of time where the user is devoted to performing income earning tasks. To provide the user with valuable data about their income earning, it can be useful to break-up an extended period of time into identifiable shifts. The system can then provide the user data about the shifts with respect to other shifts, other opportunities, other times of the day, etc.

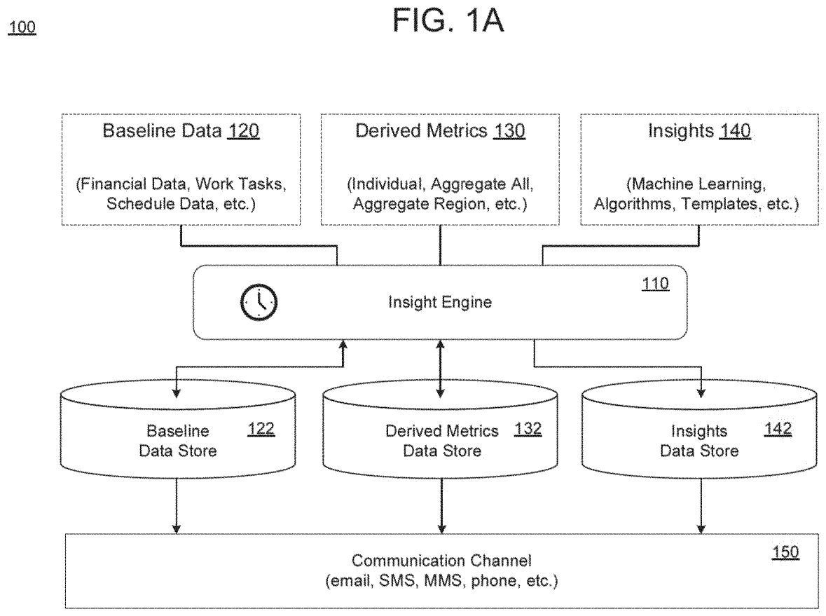

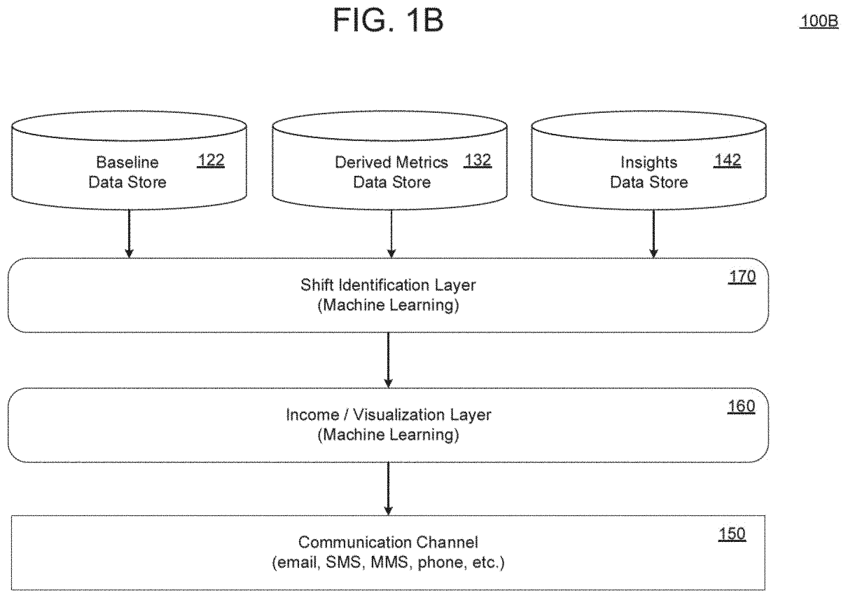

FIG. 1A illustrates an example of an insight engine 110 using baseline data 120 to derive metrics 130. The insight engine 110 may also derive insights 140 based on one or more of the baseline data 120 and the derived metrics 130. As further described below, triggers may be detected by the insight engine 110 which cause the insight engine 110 to derive metrics 130 from the baseline data 120. In addition, triggers may be detected by the insight engine 110 to derive the insights 140 from the derived metrics 130 and/or the baseline data 120. Triggers can be event-driven (e.g., based on a change in a data value, data values of other users, etc.). As another example, triggers can be time-driven (e.g., daily, weekly, monthly, etc.) The definition of what triggers the generation of a derived metric or insight is part of the insight engine 110 as is the logic regarding the evaluation of data, related calculations, and eventual output of a derived metrics 130 and the insights 140.

The insight engine 110 may retrieve the baseline data 120 from a data store 122, and generate the derived metrics 130 and the insights 140. In this example, the insight engine 110 may store the derived metrics 130 in a data store 132 and the insights 140 in a data store 142. Meanwhile, a communication channel 150 which may be controlled or otherwise configured by a software application, etc., may communicate with the databases 122, 132, and 142, and send notifications/insights to a user device (not shown). Here, the communication channel 150 may be email, SMS, MMS, phone call, or the like The insights 140 may include a textual description describing information that is relevant/helpful to the user. The insights 140 may provide the user with machine learning data, suggestions, recommendations, and the like, with respect to the tasks/jobs they are currently performing. As another example, the insights 140 may be based on an evaluation of aggregated data and/or metrics from other entities/users performing other tasks/jobs.

As an example, an insight may be created from the baseline data 120 such as a new transaction event where a deposit from working has been added to a user's account. Here, the insight may include a notification that the income event occurred, as well as an insight derived from the new transaction event such as “this brings your total for the month up to $70” which is based on both baseline data plus derived metrics.

Although FIG. 1A shows the baseline data 120, the derived metrics 130, and the insights 140 being stored in separate data stores, the embodiments are not limited thereto. As another example, the different data types may be stored together in a central data store, a blockchain, or the like.

Different triggers can be initiated by the insight engine which cause the metrics to be derived and the insights to be sent. For example, a baseline data change trigger can occur when new baseline data is received. Here, the insight engine can generate one or more derived metrics, generate an insight based on any baseline data that has changed when the new baseline data is stored, generate an insight based on a combination of baseline data and one or more derived metrics.

Another example of a trigger is a derived metrics change trigger. In this example, the insight engine can generate one or more derived metrics, generate an insight based on a derived metric that changed, generate an insight based on a combination of one or more derived metrics, and the like.

Another example of a trigger is a time-based trigger. In this example, the insight engine can derive new metrics and generate insight based on timing occurrences identified from a system clock, etc. For example, in response to a time-based trigger, the insight engine can create one or more derived metrics from baseline data, create one or more derived metrics from derived metrics, create one or more derived metrics from combination of baseline data and derived metrics, create one or more insights from baseline data, create one or more insights from derived metrics, create one or more insights from combination of baseline data and derived metrics, and the like.

Baseline data may be converted into two tiers of abstraction, referred to as derived metrics and insights, through the use of triggers. This approach includes execution of predefined triggers to analyze baseline data and store the results as derived metrics as well as a second tier of triggers that will analyze both derived metrics and baseline data in order to create Insights to be shared with relevant audiences.

For example, baseline data may include a collection of information related to an entity, such as financial transaction or work information for the users of an app. Derived metrics triggers are rules that describe how and when baseline data should be evaluated to calculate and store derived metrics as well as the engine that executes those triggers. Derived metrics triggers might also act on other derived metrics and the results stored. Derived metrics are the stored results of derived metrics triggers related to individual entities or to entity cohorts. With this approach, the derived metrics repository continually updates as derived metrics triggers execute and the repository can be used by other data consumers for purposes such as up-to-date report generation or inputs to machine-learning models. This repository can also be used as part of the foundation to create insights.

Insight triggers are similar to derived metrics triggers, but monitor both baseline data and derived metrics. The insight trigger rules and engine that executes those rules produce insights. Insights are the result of insight triggers and are generally thought of as human-friendly content that communicates valuable information to relevant individuals and audiences based on the more complex data that generates that content, although insights could certainly take on additional forms.

In the examples herein, a “trigger” is used as a more generalized concept representing an action to be taken based on something that preceded it and should not be intended as a specific technical implementation such as a database trigger on a table update operation, insert operation, delete operation, or the like.

As a non-limiting example, on the third business day of a new month (a time-driven trigger), several derived metrics triggers execute and evaluate, create, and update derived metrics. For example, a derived metric may include total income for the prior month for all users (derived metric trigger acting on baseline data to sum and store all income transactions for the previous month per user).

Another derived metric may include maximum monthly income which results in the execution of an event-driven derived metrics trigger that compares that income to the maximum monthly income for each user. The derived metric may be stored for each user. If the new monthly income is greater, the maximum monthly income derived metric is updated with that value (derived metric trigger acting on derived metric and comparing it to another derived metric to determine if an update should occur).

Another derived metric may be income by income source. Similar to the above, subtotals of income from all income sources (ride sharing, delivery, freelance, etc.) are also calculated and stored for the previous month and compared to maximum monthly income derived metrics for each income source to determine if an update is needed.

Another example derived metric is average income by income source for all users grouped by MSA (Metropolitan Statistical Area). Different than a derived metric for an individual entity/user, this represents a derived metric for an entity cohort which includes a collection of users.

Another example derived metric is average income by income source for all users grouped by primary source of income (retail, manufacturing, construction, service, etc.) The metric represents another analysis by entity cohort (i.e. average income from company A users classified as “Retail Workers”).

An example of insight is provided below. For example, a user that has achieved a new maximum monthly income from rideshare company U is sent an insight through push notification or SMS—“You made $425 driving for company U last month—a new record! That's $123 more than the average driver in Atlanta and $75 more than other retail workers that also drive for company U.” This represents an event-driven insights trigger based on the update of the new maximum income by source derived metric. Here, another event-driven insight trigger fires based on the creation of the new monthly derived metrics, creating an insight available within the app announcing the top income source for each MSA for users that don't have any history of income from that income source—“The average income from company P for people in Chicago is $784! Click to apply now.” On the 4th business day, a time-driven insights trigger sends an email to all users providing them with an overview of their income from the previous month as well as information from relevant entity cohorts. Above are only a few examples of how the various features of this model could be applied.

The baseline data may be the lowest level of data described in this approach and is received into the core of the insights engine as the starting point of the data repository that is the basis for the abstracted derived metrics and insights. Examples of baseline data include individual financial transactions such as purchases, income events, fees, and transfers, with information that might include financial institution, account identification, date, amount, category, funding source, and recipient. Additional transaction details might also be included such as—where applicable—principle, interest, and interest rate/APR information; sales tax; line item or SKU information; geographic information; etc.

Other examples of baseline data include individual or combination of work tasks such as delivery, rideshare, dog walk, or other services. Data could include, but not be limited to, source of work, total amount charged to recipient requesting task, income by worker including tip and/or bonus information, time taken to perform task(s), distance travelled, start and end location or other geographic information, start and end time, associated expenses, etc. Another example of baseline data is other work information. By way of example, this could include information on part-time or full-time work such as pay period; hours worked; schedule of hours worked; total income with details related to withholding, benefits, etc.; details of the work performed; geographic information; expenses; etc. Other examples of baseline data include geographic information by itself could also be included as baseline data, with information ranging from time-stamped Lat/long at the most basic level to a variety of supplemental information depending on the data source.

FIG. 1B illustrates an architecture 100B of a shift identification layer 170 and a income optimization and visualization layer 160 in accordance with an example embodiment. Referring to FIG. 1B, according to various embodiments, the data that is stored within any of the baseline data store 122, the derived metrics data store 132, and the insights data store 142, may be used by the shift identification layer 170 to identify shifts. Once the shifts are identified, data from the baseline data store 122, derived metrics data store 132, and insight data store 142 may be grouped or otherwise binned into subsets and used for further analysis. How shifts are identified are further described in the examples below and can include statistical analysis, machine learning, collaborative learning, and the like. The use of shifts allows the system to take a large amount of data and organize it in a way that enables the insight engine described herein to provide insight in a coherent manner.

As further shown in FIG. 1B, the income optimization and visualization layer 160 may create suggestions on how to improve/optimize income earned by a user. For example, the income optimization and visualization layer 160 may identify other users that have job categories and geographical locations that are similar to a respective user, identify better income earning opportunities for the respective user based on the other users in a collaborative manner, and output a visualization (e.g., email, electronic message, in-app window notification, etc.) with the recommended income earning opportunity. These recommendations can be based on the shifts that are identified by the shift identification layer 170.

Here, the income optimization and visualization layer 160 may receive data from one or more of the baseline data store 122, the derived metrics data store 132, and the insights data store 142, organize the data based on shifts identified by the shift identification layer 170, and convert the data into predictions, and output the predictions via one or more communication channels 150. The recommendations that are provided to the user may include new employment opportunities at different organizations than where the user currently works, different employment opportunities at an organization where the user currently works, a change to a work schedule, a change in jobs altogether, a change in geographical area in which to perform the job, and the like. In some embodiments, the machine learning layer 160 may be used to predict training courses, educational classes, licenses to obtain, etc. to help the user improve their income earning opportunities.

The income optimization and visualization layer 160 may include a plurality of machine learning models that are interconnected with each other. For example, depending on the type of prediction to be made (e.g., job recommendation, schedule change recommendation, training, etc.), the income optimization and visualization layer 160 may execute a different sequence of machine learning models. For example, a job recommendation prediction may include a plurality of machine learning models being executed on different input data. The “ensemble” of machine learning models may be selected by a service on the host platform based on the type of prediction to be made. An output of a first machine learning model may be routed to an input of a second machine learning model, enabling a cascading execution of machine learning models.

The machine learning models may receive different input data. In some cases, the machine learning models may receive the same or partially overlapping input data. The host platform may select a “route” through the machine learning layer based on the type of prediction being performed.

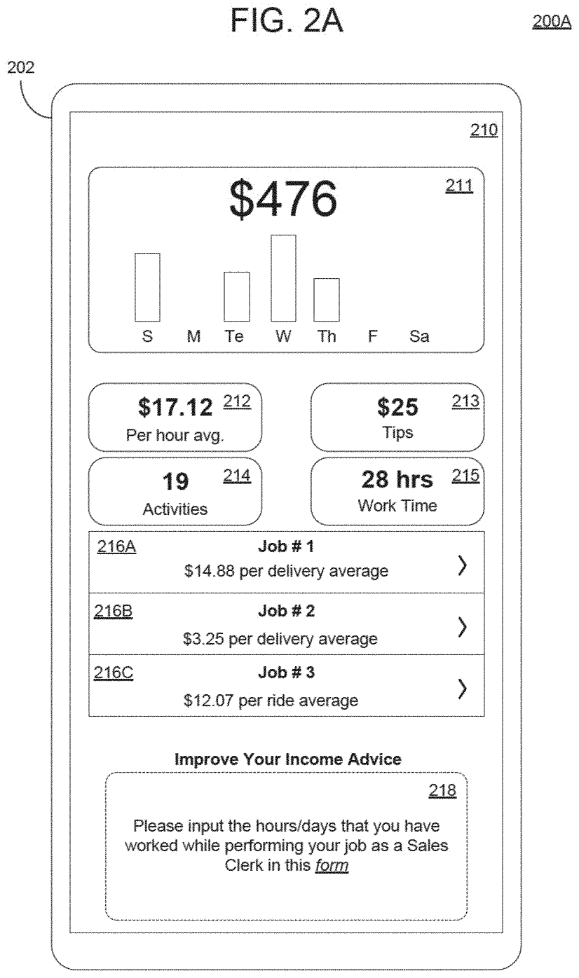

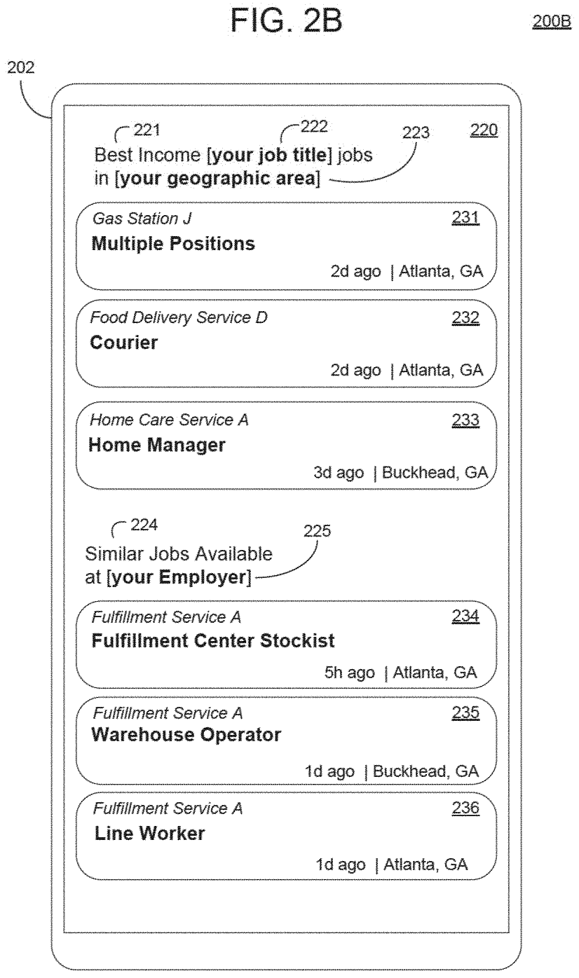

FIGS. 2A and 2B illustrate examples of a user interface for displaying insight and recommendations in accordance with example embodiments. According to various examples herein, the recommendations and insight created by the income optimization and visualization may be output via one or more of a message, an email, an in-app user interface, and the like. To output the recommendation, a template or frame may be selected and populated with both information from the prediction and information from the data used to make the prediction. The template/frame may include predefined content that is embedded therein with blank spaces where content from the prediction and content used to make the prediction can be inserted. Which template/frame to use may be selected by the host platform based on the recommendation being output. For example, an income visualization (FIG. 2A) may have a different format and data blanks than a job recommendation visualization (FIG. 2B). The templates may be predefined in advance and stored within a memory of the host platform.

FIG. 2A illustrates a process 200A of display data to a screen of a mobile device 202 which includes a user interface 210 that is output from a host server/cloud such as host platform 100 shown in FIGS. 1A-1B. The user interface 210 includes a window 211 which has a display of the amount of income earned for the most recent week. The window 211 further includes bar graphs that break down income on a daily basis. In this example, the user is someone who has three (3) different temporary jobs The system can aggregate data from across the three different jobs and provide a comprehensive and organized understanding of the data. In this example, the window 211 includes daily earnings combined from all three of the users jobs.

Furthermore, window 212, 213, 214, and 215, show additional details associated with the user's income for the week. For example, window 212 displays the average amount earned per hour over the week from all three jobs, window 213 shows the number of tips received from all three jobs, window 214 shows the number of activities performed by the user (e.g., rides, deliveries, etc.), and window 215 shows the total amount of time worked to generate the income for the week. The user interface 210 further includes additional bars 216A, 216B, and 216C with additional information about each of the three jobs performed. Each of the windows 211, 212, 213, 214, and 215, and the bars 216A, 216B, and 216C, and be selected by the user to further drill down into the information associated therewith.

In some embodiments, the user interface 210 may include a window 218 or something similar which provides income advice to a user. When the user selects on button, etc., the user may be provided with additional suggestions/recommendations on how to improve their income. For example, the host platform may proactively make recommendations for where, when, and what work opportunities would optimize income for a particular user based on the user's schedule, the user's current availability, existing job opportunities listed on a website, stored in a database, etc. The host platform may capture income earning information/data from a community of users and gain insight based on the community as a whole. Therefore, the host platform can provide individual suggestions to a particular user based on the user's attributes and also income earning information of the community of users. In some embodiments, the host platform may identify compensation model trends that might indicate one source of income becoming more or less lucrative, provide a comprehensive report on tax-related data—such as mileage—that would identify tax-benefits for the worker, recommend other income sources that might be of interest for the worker, and the like.

You work for a first company, but you may be able to make more working for a second company. The user interface could provide this information within the income advice window 218.

### Work Data

### Types of Data

The type of data collected for the solution proposed can consist of, but not be limited to:
General Employment Information
   Employer information (industry codes/categories, employer name, etc)
   Employment type (full time, part time, etc)
   Employee category (W-2, 1099, etc)
   Employment history (start date, end date, specific shift details, etc)
   Job Title and Job Title History
   Compensation rate (Annual Salary, Hourly Rate, etc)
   Payment schedule (daily, weekly, bi-weekly. Monthly, etc)
   Employment and/or Home address. Especially useful for looking up tax rates for worker
   Marital Status
   Tax deductions
Income and expense information
   Pay period history
   Income details (wages, tips, bonuses, commissions, royalties, expense reimbursement, etc)
   Withholding details (Federal tax, state tax, Medicare, Social Security, 401k, Health Insurance, etc)
   Expense information
   Summary information of the above (Month to date, year to date, etc)
Other information, frequently relevant for, but not limited to gig work
   Individual task information
      start/end time
      start/end location
      Weather and other events happening within a predetermined distance of the latitude and longitude of the user device
      Financial break down of task(s) (Charged price of customer, expenses, direct income, tips, bonuses, expenses, fees, etc)
      Other details of task(s) (type of service; number of deliveries, rides, walks, etc; number of riders; distance; rating; feedback on task(s)
Constraint information
   Available work schedule
   Skills and attributes that might be prerequisites for certain types of work (i.e. experience working with POS system or as a bartender)
   Available resources (i.e. having a car for delivery jobs)

### Sources of Data

Data could be collected through a variety of mechanisms, including, but not limited to:
Direct access of data from a 3rd party data source
Electronic transmission/replication of data from 3rd party data sources
Electronic transcription of relevant data via means such as “web crawlers”
Manual entry of data from workers or others
Automatic data from the user's device such as GPS data, etc.
Transcription of data either manually or through electronic tools such as OCR (i.e. scanning in of paystub, W-2, etc).
   3rd party data sources could include, but are not limited to:
Direct connection with employer/income source
Payroll service providers
Governmental agencies such as the IRS
3rd party companies or organizations that provide services to aggregate this type of information
Weather and local event data sources as well as the GPS data from the user device
Traffic information from government and/or commercial data providers
   The types of data described can be organized and analyzed to provide workers with a better understanding of their income in order to help them make informed decisions. The image below represents one possible example.
   FIG. 2A includes an example of income earned by a worker over the course of a week broken down by day and income source—in this case, DOORDASH® (Job #1), POSTMATES® (Job #2), and LYFT® (Job #3). They also are shown metrics of effective income per hour, tips, total activities/tasks performed (i.e. delivery and rideshare) total hours worked, and income per delivery or rideshare by income source.
   The worker can explore this data by drilling into a detailed view of income by day or by income source. Different income sources may have different details based on the available data. In the case of LYFT®, location information is available resulting in a map of activities as well as a breakdown of income per mile and total mileage.
   Also shown in the Daily Income breakdown across all income sources is a “Tips” bubble at the bottom of the screen that offers ideas that might help the worker based on the work data we have for them. This could consist of a range of suggestions ranging from advice from other workers to products and services that might be relevant and useful to the worker based on their data.
   From this data, workers can make better informed decisions about when and where to do which job, understand which sources of income are more effective for them, identify potential work-related costs, and see information that might have tax implications—the latter two related to the mileage required to perform this work.
   More advanced features could analyze the available data for the worker—combined with data from other, similar workers—and proactively make recommendations for where, when, and what work would optimize income, identify compensation model trends that might indicate one source becoming more or less lucrative, provide a comprehensive report on tax-related data—such as mileage—that would identify tax-benefits for the worker, recommend other income sources that might be of interest for the worker, etc. The worker could provide scheduling information and location preference to further improve recommendations or these types of factors could be predicted by the recommender based on historic and other information for the worker (i.e. historic times of work and home location).
   In some embodiments, the system may use machine learning, collaborative filtering, look-alike modeling, statistical modeling, and/or the like, to identify patterns and trends in income optimization. Data from a community of users of the system may be analyzed to provide recommendations for optimizing income to a particular user based on the respective user's current income earning jobs and what other users in the community are doing.
   While the example uses data from gig income sources, this could be extended to include other types of work. For example, income from a full-time or part-time job and data associated for the particular type of work such as schedules and shifts, health insurance and retirement programs with associated contributions, tax and other withholding information, etc. The goal being to provide a comprehensive overview of work in a single place so workers are informed and can make work and financial decisions to better meet their needs assisted by recommendations from the solution to reduce mental effort of the worker.

### Some of the Benefits of the System

Collect or provide a means to collect data related to work income.
Present work data and derived analysis of data to workers
Analyze individual worker data combined with other workers' data to offer insights and recommendations on how to better accomplish their goals, which might include improving income, optimizing time, minimizing expenses, etc.
Recommend new sources of income
Recommend new skills or certifications that will help works increase their income
Offer optimized work schedules for workers
Organize data for workers to facilitate other activities, such as identifying tax-related expenses.
Offer users financial or other products based on their data. For instance, car insurance or fuel discounts for delivery drivers, 401k or SimpleIRA plans for workers without such plans from their employer, etc.

FIG. 2B illustrates a process 200B of displaying job recommendations via an in-app user interface 220 displayed on the mobile device 202 in accordance with an example embodiments. Referring to FIG. 2B, the host platform has identified (e.g., via machine learning) recommended job opportunities for a particular user that will likely improve the income earned by the user. In this example, the process 200B includes the host platform selecting a template that includes the user interface 220 having a first description 221 and a second description 225 embedded in the template and which are to be filled-in with data of the user. Here, the template may include a frame/page of content from a mobile application or a web page/web application with blank spaces of content to be filled in. In this example, the first description 221 includes space 222 and space 223 to be filled in with user data. In particular, the space 222 is to be filled in with a description of a job title (e.g., warehouse technician, grocery stockiest, delivery driver, etc.). Furthermore, the space 223 is to be filled in with a description of a geographic area (e.g., Chicago, Ill., Atlanta, Ga., New York, N.Y., etc.).

Underneath the description 221 is a list of recommended job opportunities 231, 232, and 233 which include details of the job such as title, company, day/time of posting, geographic location, etc. In this example, the machine learning identifies the best income earning jobs for the user based on job opportunities in the same field that the user currently works in, and the same geographical area that the user currently works in. Thus filters can be applied to the data to reduce the data processed by the machine learning models. For example, a filter may be used to limit the geographical area of the jobs, and another filter may be used to limit a job category/type of the jobs.

The description 224 includes a blank space 225 to be filled-in with a name of a current (or most recent) employer of the user. Underneath the description 224 is a list of recommended job opportunities 234, 235, and 236 which include details of the job such as title, company, day/time of posting, geographic location, etc. In this example, the machine learning identifies the best income earning jobs for the user based on job opportunities at the same employer. Thus filters can be applied to the data to reduce the data processed by the machine learning models. For example, a filter may be used to limit the employer to a particular company, subsidiary, etc.

According to various embodiments, the shift detection software described herein has the ability to identify tasks with varying degrees of information, from complete transparency and data availability of tasks to missing start/end times, to no specific task information at all. In the latter case, the software can extrapolate additional context of the shift based on patterns such as linger times (wait times within a predetermined latitude and longitude in the GPS data), pattern matching and community insights identified via machine learning (e.g., collaborative learning, etc.), and the like. Furthermore, the shift detect software has the ability to tasks identified into different shifts. In doing so, the shift identification software provides parameters (shift starting and end times) which can be used to query a database for information about the user and other users based on the shift starting and end times.

The data that is used for shift identification may include entries made by the user via a user interface. For example, a user opens an app and toggles on when they begin work and toggles off when they stop work. The user thus manually specifies the shift. As another example, the host platform may have access to work data from sources like gig platforms, paystubs, etc. that provide complete shift data (worked on specific date from start time to end time, etc.) As another example, the system may use task information when a shift is comprised of multiple tasks such as rideshare, delivery, etc. This could be details that include start time, end time, start lat/long, end lat/long, and the like. As another example, the platform may predict the shift start time and end time based on predictive models, etc. The source data could include GPS and drive time data from a mobile or similar device.

If a data source only provides start time of a task, the host platform may look at a collection of start times and, in a simplistic model, and assume that each task has an end time a predetermined amount of time (e.g., 1 second, etc.) before the start time of the next task even if tasks are from different “employers.” In the case of an excessive time gap between start times (eg 60 minutes), the system can assume the worker took a break and calculate the estimated end time of the task preceding the time gap to be the average of all tasks performed using the start time logic of duration within a “shift.” (eg when a worker has a collection of start times for tasks with each gap less than 60 minutes). The new task beginning more than 60 minutes after the previous task, would represent a new shift in this example. Similar logic could be applied in the case that only end time of task was provided.

However, such simplistic modeling is not always accurate. Therefore, the example embodiments may use machine learning to train a model based on historical task data of other users including geolocation information, driving information, timing information, source of work, and the like, to generate a predictive model capable of receiving live data (driving data, geolocation data, timing information, etc.) such as that captured by a mobile device, and predict start/stop times of each task and each shift which may be comprised of multiple tasks.

A shift in the actual world is defined as the period of time that a worker is actively working or looking for work, whether or not they are able to find a task. It is possible for a user to manually specify when they are working shifts—either by toggling on/off that they are working or entering in start/end times of historic shifts, but the example embodiments can identify shifts when such expressly provided data is not there. For example, the host platform can use machine learning models based on individual or community behavior and lookalike audiences can also be used for this determination.

The shift determination software may run as a process on internal servers of the host platform based on the data collected from an individual and the community at large. This information would then be used to drive metrics, insights, and features for the user—sourced from the centralized intelligence. The shift logic could be returned to the user's mobile application for user review, but may also be used internally for analysis. For example, the user might want to see the shifts they've worked over a period of time (API return of data to the app), however, the user might also want to see a breakdown of income per hour, in which case the income earned would be divided by the shift duration. That calculation could be done at the app level itself, or centrally so it could be used as a historical analysis or fed into machine learning models to benefit others in the community.

One of the benefits of identifying the shift data (start and end times) is that it gives the host platform parameters that can be used to collect data, query data stores, generate metrics, generate insights, predict changes to improve income, predict changes to the user's schedule, and the like.

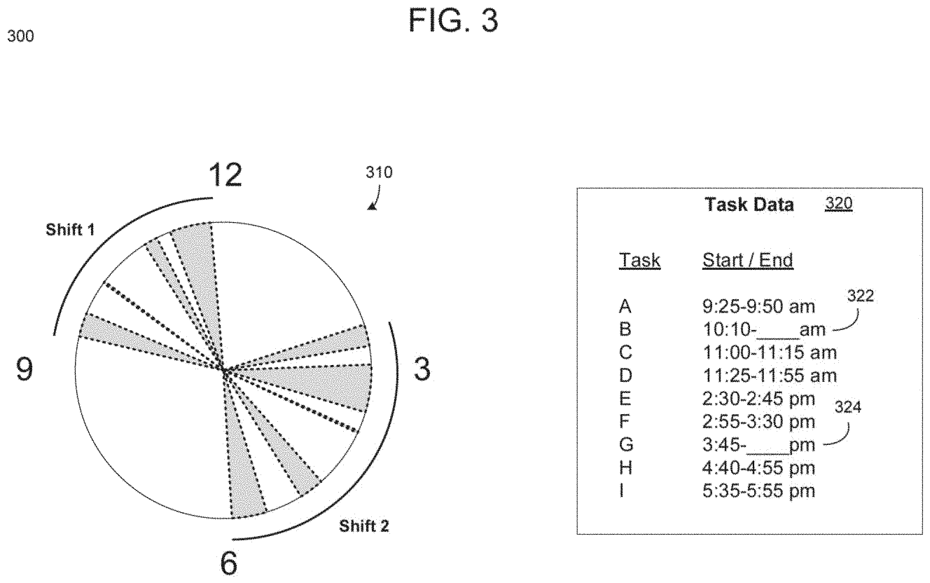

FIG. 3 illustrates tasks performed by a user over a period of time in accordance with an example embodiment. Referring to FIG. 3, a time chart 310 is shown in which two shifts are identified based on nine different tasks that are performed. Here, the user may provide task data 320 which includes start times and end times of the tasks, as well as other additional information such as geography, type of task, etc. In this example, the task data 320 is missing an end time 322 for task B and an end time 324 for task G.

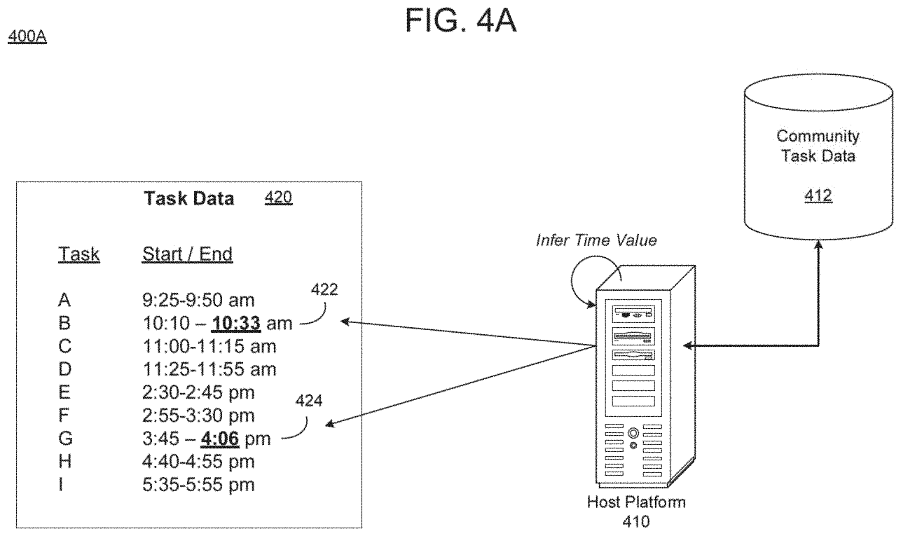

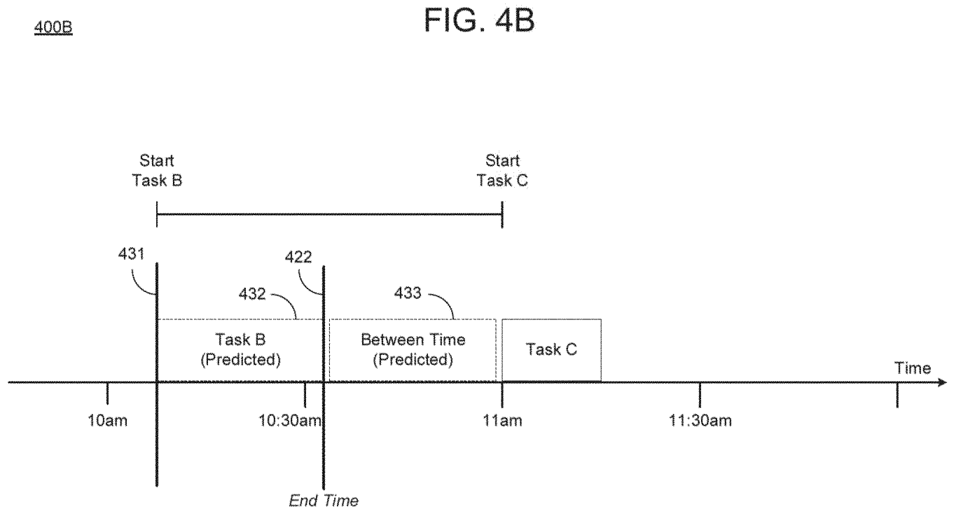

FIGS. 4A-4B illustrate a process of imputing an end time for a task in accordance with an example embodiment. Referring to FIG. 4A, a process 400A is shown in which a host platform 410 imputes/infers end times 422 and 424 for tasks B and G, respectively. For example, the host platform 410 may analyze community data 412 which includes task information of other users on the host platform 410. This community data may be used to train one or more models (e.g., statistical models, machine learning models, etc.) which can then be used to predict the start/end times of tasks and/or shifts. The host platform 410 may analyze all users together via collaborative filter or identify a subset of users that are most closely related to the target user and use only the subset of users' data. For example, the host platform 410 may identify the subset of users based on location, time of day, type of task, and the like.

FIG. 4B illustrates a process 400B of determining the end time 422 of task B. In this case, the model that is generated from community data 412 may be used to estimate an in-between time 433 since the task relates to a delivery service. The in-between time 433 may represent time that the user expends travelling from task B to task C. The in-between time 433 may be estimated by the host platform 410 based on actual in-between times of other users performing similar tasks in the same geography, etc. Based on the estimated in-between time 433, the host platform 410 can determine an overall time that a task takes which includes actual task time plus the in-between time. Using this information, the host platform 410 may subtract the in-between time 433 from the amount of time between the start of task B and the start of task C, to determine the end of task B (end time 422). The host platform 410 may fill-in the missing end times 422 and 424 to create the filled-in task data 420.

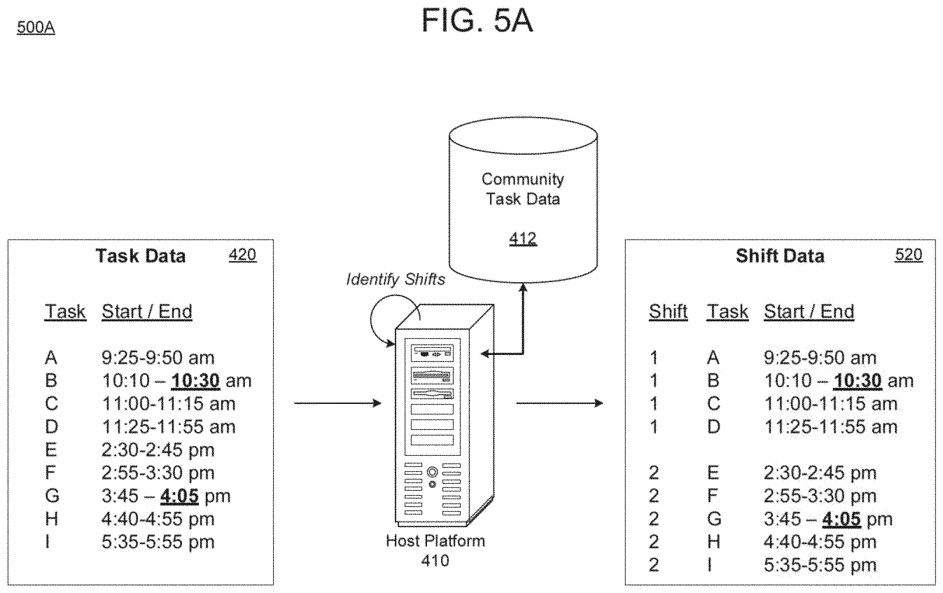

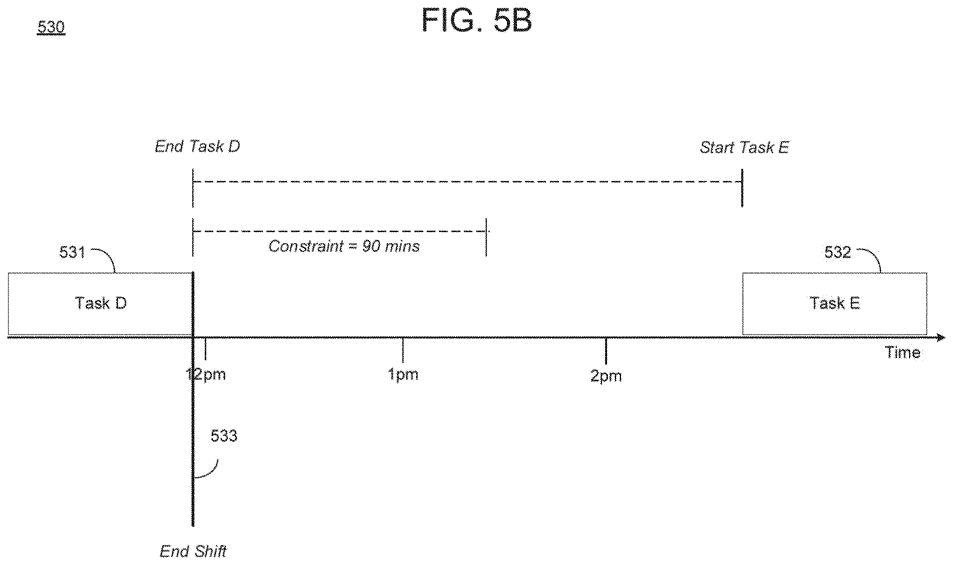

FIGS. 5A-5B illustrate a process of identifying shifts from a group of tasks in accordance with an example embodiment. Referring to FIG. 5A, in a process 500A, the host platform 410 may identify shifts within the task data 420. For example, the host platform 410 may determine the amount of time between an end time of a first task and a start time of an immediately subsequent task from among two consecutive tasks. If the end time of the first task and the start time of the second task are within a predetermined range of time (e.g., within 90 minutes, etc.) the two tasks may be considered as part of the same shift. However, if the end time of the first task and the start time of the second task is greater than the predetermined period of time, the host platform 410 may determine a first shift has ended and a second shift has begun.

As shown in FIG. 5B, two consecutive tasks 531 and 532 are shown on a graph over time. In this example, a time between an end time of task D 531 and a start time of task E 532 exceeds a predetermined threshold (constraint of 90 minutes). Therefore, the host platform 410 determines that a new shift has started between tasks D 531 and E 532 at a shift end position 533 which is the end time of task D. The host platform 410 may then label each task data item with a shift identifier to create the shift data 520.

The host platform 410 (or some other system) may perform analysis on the data based on particular shifts. The analysis may be used to provide insight to users about the income they have earned, better income opportunities, changes they can make, etc.

For example, shifts may be determined from the beginning of a task to the end of another task where the end time of the previous task and the beginning of the next task is within the constraint (e.g., 60 minutes or some such). By way of example, if someone gets a ride for 100 miles that takes 2 hours and then the worker immediately picks up a delivery for a bakery, the shift is from the start time of the 100 mile journey to the end of the bakery delivery—basing it only on start times would put the two tasks in separate shifts. In this case, the system can use the end time of the previous task and the start time of the next task to determine whether shift has ended. When the system detects that the shift has ended, the system uses the end time of the last task in the sequence as an end time for the shift.

In some embodiments, the system may adjust for a slight nuance which happens in scenarios where a worker performs overlapping tasks, for example, a driver picks up one delivery from company A and on the way to completing the delivery, picks up a second delivery from company B. Now there are 2 overlapping tasks. The shift logic may recognize this and base its calculation on the one that ends later . . . and then sees if the next task in sequence (e.g., a car service ride) is within the cutoff filter time (˜60 minutes) so it is included in the shift or begins a new shift.

In this example, a shift would begin with the start of the first task in sequence and end with the completion of the last task in sequence, which end date might be available or calculated by the host platform 610 and/or the community data 612. The results in 720 can accommodate for the above overlapping scenario.

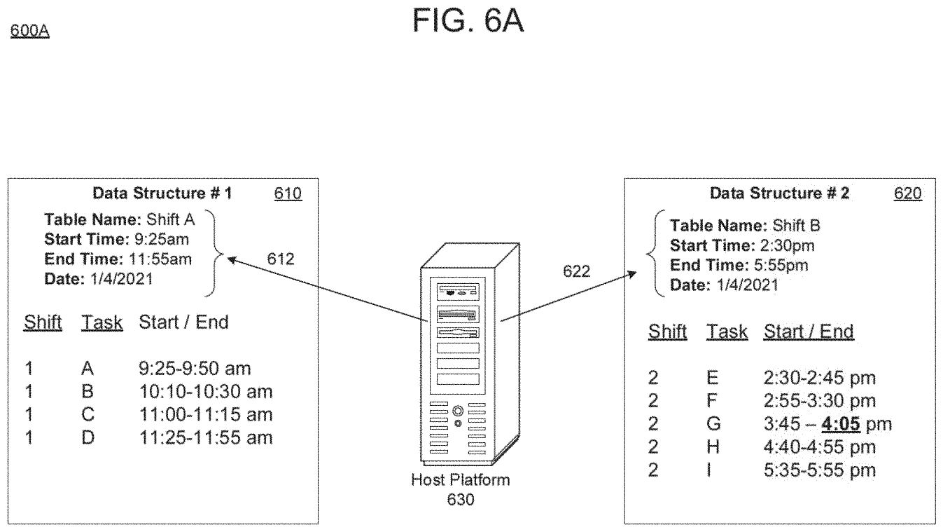

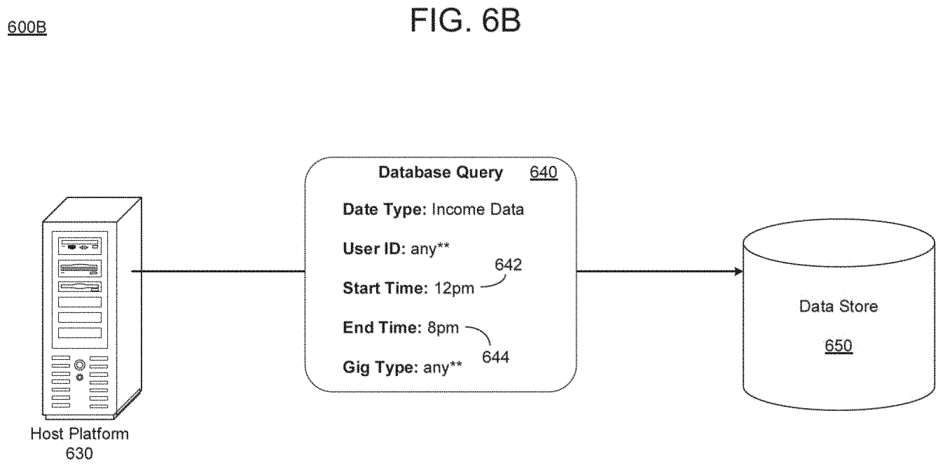

FIG. 6A illustrates a process 600A of organizing data based on detected shifts in accordance with an example embodiment, and FIG. 6B illustrates a process 600B of querying data based on shift parameters in accordance with an example embodiment. Referring to FIG. 6A, a host platform 630 has identified two separate shifts of user data and stores the data in two separate data structures 610 and 620. Here, the data structures 610 and 620 may include tables, database topics, documents, or the like. Each of the data structures 610 and 620 may include shift content (e.g., timing data, GPS data, income earned data, etc.) that is associated with each of the shifts.

According to various embodiments, the host platform 630 may label each of the data structures 610 and 620 based on the identified shift information. For example, the host platform 630 may add a label 612 to the data structure 610 which includes a shift identification (unique identifier within the data store), a start time, an end time, a date, and the like, of the shift data associated with the first shift. As another example, the host platform 630 may add a label 622 to the data structure 620 which includes a shift identification (unique identifier within the data store), a start time, an end time, a date, and the like, of the shift data associated with the first shift.

Referring to FIG. 6B, a data store 650 that stores the shift data (e.g., based on the data structures 610 and 620, etc.) may be queried using any desired database query such as a structured query language (SQL) query, a topic query, or the like. In the process 600B of FIG. 6B, the host platform 630 transmits a query 640 that includes a parameter 642 of a start time and a parameter 644 of an end time of data that is desired to be retrieved by the query 640. The query 640 may be a request for income data for shifts that are performed at any point between the start time 642 and the end time 644. Here, the query 640 will return one or more data structures that meet the requested parameters included in the query 640. Referring again to the example of FIG. 6A, the second data structure 620 because the shift B is between the requested time parameters 642 and 644 in the query 640, while in the first data structure 610 will not be returned since the times of shift A stored in the first data structure 610 to not meet the time parameters 642 and 644 in the query 640.

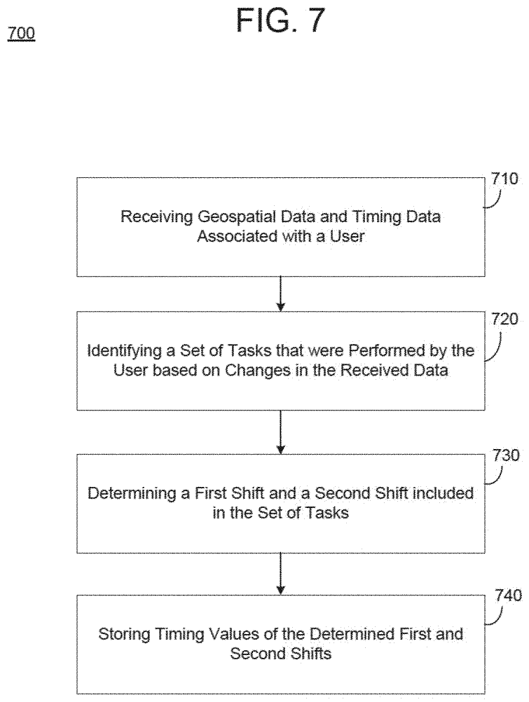

FIG. 7 illustrates a method 700 a method of detecting a shift within user data in accordance with an example embodiment. As will be appreciated, the example of FIG. 7 is just one example of a flow, and is not limited thereto. Furthermore, one or more of the steps shown in FIG. 7 may be omitted and/or performed in a different order. Also, different steps may be included which are not shown. For example, the method 700 may be performed by a host platform receiving data from different external sources, via the Internet. As an example, the host platform may be a web server, a cloud platform, a database, and the like.

In 710, the method may include receiving, via a processor, geopositional data and timing data from a computing device associated with a user. In 720, the method may include identifying, via the processor, a set of tasks that were performed based on changes in one or more of the geopositional data and the timing data. In 730, the method may include determining, via the processor, that a first subset of tasks from the set of tasks are included in a first shift and a second subset of tasks from the set of tasks are included in a second shift based on a gap in time between a last task of the first subset and a first task of the second subset. In 740, the method may include storing, via the processor, timing values of the determined first and second shifts in a data store.

In some embodiments, the method may further include executing a machine learning model which determines an optimal shift for the user based on collaborative filtering, and inputting the determined first and second shifts into the executing machine learning model. In some embodiments, the identifying may include identifying a first task and a second task as being included in the first shift in response to a geolocation value of the user during the first task and a geolocation value of the user during the second task being within a predetermined distance value.

In some embodiments, the identifying may include predicting one or more of a start time and an end time of a task from among the set of tasks via execution of a machine learning model on the geopositional data and the timing data, and determining that the task is included in the first subset of tasks based on the one or more of the predicted start time and the predicted end time. In some embodiments, the determining may further include determining that the first subset of tasks are included in the first shift based on a gap in time between each task in the first subset of tasks being less than a predetermined threshold.

In some embodiment, the method may further include loading user data associated with the first shift into a first data structure and loading user data associated with the second shift into a second data structure, and storing the first and second data structures in a data store. In some embodiments, the method may further include labelling the first data structure with an identifier of the first shift and labelling the second data structure with an identifier of the second shift. In some embodiments, the method may further include receiving a request for the user data associated with the first shift and retrieving the first data structure from the data store based on the labeled identifier of the first shift.

The above embodiments may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

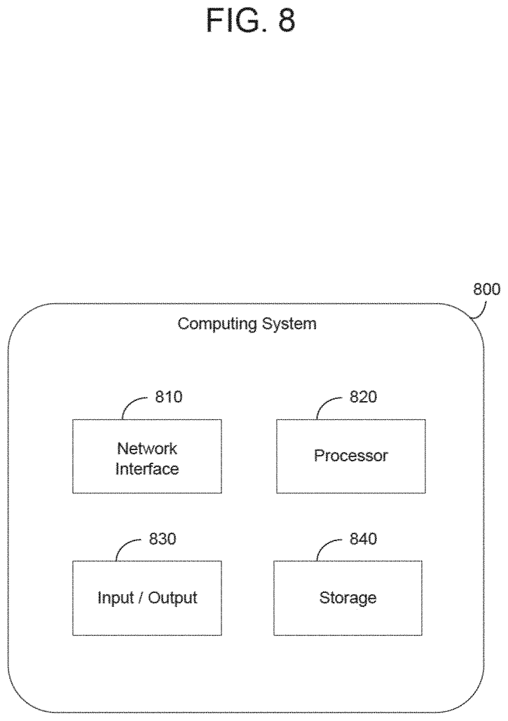

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 8 illustrates an example computing system 800 which may represent or be integrated in any of the above-described components, etc. FIG. 8 is not intended to suggest any limitation as to the scope of use or functionality of embodiments described herein. The computing system 800 is capable of being implemented and/or performing any of the functionality set forth hereinabove.

The computing system 800 may include a computer system/server, which is operational with numerous other general purpose or special purpose computing system environments or configurations. Examples of well-known computing systems, environments, and/or configurations that may be suitable for use as computing system 800 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, databases, and the like, which may include any of the above systems or devices, and the like. According to various embodiments described herein, the computing system 800 may be a tokenization platform, server, CPU, or the like.

The computing system 800 may be described in the general context of computer system-executable instructions, such as program modules, being executed by a computer system. Generally, program modules may include routines, programs, objects, components, logic, data structures, and so on that perform particular tasks or implement particular abstract data types. The computing system 800 may be practiced in distributed cloud computing environments where tasks are performed by remote processing devices that are linked through a communications network. In a distributed cloud computing environment, program modules may be located in both local and remote computer system storage media including memory storage devices.

Referring to FIG. 8, the computing system 800 is shown in the form of a general-purpose computing device. The components of computing system 800 may include, but are not limited to, a network interface 810, one or more processors or processing units 820, an output 830 which may include a port, an interface, etc., or other hardware, for outputting a data signal to another device such as a display, a printer, etc., and a storage device 840 which may include a system memory, or the like. Although not shown, the computing system 800 may also include a system bus that couples various system components including system memory to the processor 820.

The storage 840 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random access memory (RAM) and/or cache memory. As another example, storage device 840 can read and write to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, storage device 840 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Although not shown, the computing system 800 may also communicate with one or more external devices such as a keyboard, a pointing device, a display, etc.; one or more devices that enable a user to interact with computer system/server; and/or any devices (e.g., network card, modem, etc.) that enable computing system 800 to communicate with one or more other computing devices. Such communication can occur via I/O interfaces. Still yet, computing system 800 can communicate with one or more networks such as a local area network (LAN), a general wide area network (WAN), and/or a public network (e.g., the Internet) via network interface 810. As depicted, network interface 810 may also include a network adapter that communicates with the other components of computing system 800 via a bus. Although not shown, other hardware and/or software components could be used in conjunction with the computing system 800. Examples include, but are not limited to: microcode, device drivers, redundant processing units, external disk drive arrays, RAID systems, tape drives, and data archival storage systems, etc.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described regarding specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a processor configured to
receive geopositional data and timing data from a computing device associated with a user,
identify a set of tasks that were performed based on changes in one or more of the geopositional data and the timing data, and
determine that a first subset of tasks from the set of tasks are included in a first shift and a second subset of tasks from the set of tasks are included in a second shift based on a gap in time between a last task of the first subset and a first task of the second subset; and
a storage configured to store timing values of the determined first and second shifts in a data store.

2. The computing system of claim 1, wherein the processor is further configured to execute a machine learning model which determines an optimal shift for the user based on collaborative filtering, and input the determined first and second shifts into the executing machine learning model.

3. The computing system of claim 1, wherein the processor is configured to identify a first task and a second task as being included in the first shift in response to a geolocation value of the user during the first task and a geolocation value of the user during the second task being within a predetermined distance value.

4. The computing system of claim 1, wherein the processor is further configured to predict one or more of a start time and an end time of a task from among the set of tasks via execution of a machine learning model on the geopositional data and the timing data, and determine that the task is included in the first subset of tasks based on the one or more of the predicted start time and the predicted end time.

5. The computing system of claim 1, wherein the processor is configured to determine that the first subset of tasks are included in the first shift based on a gap in time between each task in the first subset of tasks being less than a predetermined threshold.

6. The computing system of claim 1, wherein the processor is further configured to load user data associated with the first shift into a first data structure and load user data associated with the second shift into a second data structure, and store the first and second data structures in a data store.

7. The computing system of claim 6, wherein the processor is further configured to label the first data structure with an identifier of the first shift and label the second data structure with an identifier of the second shift.

8. The computing system of claim 7, wherein the processor is further configured to receive a request for the user data associated with the first shift and retrieve the first data structure from the data store based on the labeled identifier of the first shift.

9. A method comprising:
receiving, via a processor, geopositional data and timing data from a computing device associated with a user;
identifying, via the processor, a set of tasks that were performed based on changes in one or more of the geopositional data and the timing data;
determining, via the processor, that a first subset of tasks from the set of tasks are included in a first shift and a second subset of tasks from the set of tasks are included in a second shift based on a gap in time between a last task of the first subset and a first task of the second subset; and
storing, via the processor, timing values of the determined first and second shifts in a data store.

10. The method of claim 9, further comprising executing a machine learning model which determines an optimal shift for the user based on collaborative filtering, and inputting the determined first and second shifts into the executing machine learning model.

11. The method of claim 9, wherein the identifying comprises identifying a first task and a second task as being included in the first shift in response to a geolocation value of the user during the first task and a geolocation value of the user during the second task being within a predetermined distance value.

12. The method of claim 9, wherein the identifying comprises predicting one or more of a start time and an end time of a task from among the set of tasks via execution of a machine learning model on the geopositional data and the timing data, and determining that the task is included in the first subset of tasks based on the one or more of the predicted start time and the predicted end time.

13. The method of claim 9, wherein the determining further comprises determining that the first subset of tasks are included in the first shift based on a gap in time between each task in the first subset of tasks being less than a predetermined threshold.

14. The method of claim 9, further comprising loading user data associated with the first shift into a first data structure and loading user data associated with the second shift into a second data structure, and storing the first and second data structures in a data store.

15. The method of claim 14, further comprising labelling the first data structure with an identifier of the first shift and labelling the second data structure with an identifier of the second shift.

16. The method of claim 15, further comprising receiving a request for the user data associated with the first shift and retrieving the first data structure from the data store based on the labeled identifier of the first shift.

17. A non-transitory computer-readable medium comprising instructions which when executed by a processor cause a computer to perform a method comprising:
receiving geopositional data and timing data from a computing device associated with a user;
identifying a set of tasks that were performed based on changes in one or more of the geopositional data and the timing data;
determining that a first subset of tasks from the set of tasks are included in a first shift and a second subset of tasks from the set of tasks are included in a second shift based on a gap in time between a last task of the first subset and a first task of the second subset; and
storing timing values of the determined first and second shifts in a data store.

18. The non-transitory computer-readable medium of claim 17, wherein the method further comprises executing a machine learning model which determines an optimal shift for the user based on collaborative filtering, and inputting the determined first and second shifts into the executing machine learning model.

19. The method of claim 9, wherein the identifying comprises identifying a first task and a second task as being included in the first shift in response to a geolocation value of the user during the first task and a geolocation value of the user during the second task being within a predetermined distance value.

20. The method of claim 9, wherein the identifying comprises predicting one or more of a start time and an end time of a task from among the set of tasks via execution of a machine learning model on the geopositional data and the timing data, and determining that the task is included in the first subset of tasks based on the one or more of the predicted start time and the predicted end time.
